(19) United States
(12) Patent Application Publication
(10) Pub. No.: US 2004/0139143 A1
(43) Pub. Date: Jul. 15, 2004

(54) Multi-dimensional navigation for a web browser

(76) Inventors: Sri K. Canakapalli, Hillsboro, OR (US); Jim Jarman, Lehi, UT (US); Heather Thomas, Salt Lake City, UT (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/335,186

(22) Filed: Dec. 31, 2002

(51) Int. Cl. G06F 15/16

(52) U.S. Cl. 709/200

(57) ABSTRACT

A web navigation scheme is disclosed that allows for a multi-dimensional navigation by a method such as a one-click command on a navigational button. The web navigation scheme preserves a multiple-dimension map that a user has created by browsing. Accordingly, the user can retrace a search path in more than a simple, forward-and-back path.

### TECHNICAL FIELD

Embodiments of the present invention relate to a web browser that allows the user to back-track in more than one dimension. One embodiment relates to the use of“up” and “down” buttons on the user interface.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawing hereto: Copyright© 2002, Intel Corporation, All Rights Reserved.

### BACKGROUND INFORMATION

Web navigation buttons are a major avenue of ingress and egress for a user who is navigating within or between network resources, e.g., web sites or other networked resources. (For convenience herein, browsing will be discussed with respect to web pages, but the description is intended to apply to any browsable network resource.) During a user's browsing session, either inter-web-page (within a web page) or intra-web-page (between web sites), or both, a navigation tool of choice is often the “back” and “forward” buttons that are on a browser toolbar.

While browsing, the browser tracks a history of browsed web pages. The forward and back buttons allow one to quickly traverse web pages of a browsing session. Such history traversal is convenient as it allows backing past a particular web page to a previous web page, and then branching off from the previous web page to a new web page different from the particular web page. However, once a user has branched off from the previous network resource, the previous history going forward from the particular web page cannot be retraced. The forward and back buttons now will only traverse the history including the new web page. Navigation through web pages is linear and limited.

For example, a user is on a first page identified by a first uniform resource locator (URL), when the browser is opened, clicks on a first link, and accesses a first page. Next, the user clicks on a second link and accesses a second page, and so on. Then, finally the user clicks on the Back button the number of times it takes to get back to the first page. Next, from the first page, the user types in a second URL and accesses a second page at a second URL. At this point in the navigation through the pages, the user loses the ability to easily access all other pages he has visited, except the first page of the first URL, and the first page of the second URL.

FIG. 1 is a schematic of conventional navigational buttons that include Forward 110 and Back 112 buttons illustrating the active/inactive states of the Forward and Backward buttons during a browsing session. In FIG. 1A, where a navigational button is illustrated as an open arrow shape, it is assumed to be “grayed out” according to conventional usage such that a mouse-click on a grayed-out button does not result in a navigation action. Contrariwise, where a navigational button is illustrated as a closed arrow shape (see Back button 112 in FIG. 1B, for example), it is assumed to be active according to conventional usage such that a mouse-click on a grayed-out button can result in a navigation action. A user starts by opening a web browser, by way of non-limiting example, to a first URL, www.msn.com. It is noted that all buttons are grayed out as no history has yet been recorded.

At FIG. 1B, the user clicks on a link and moves to a second URL for carpoint.msn.com. Now, the Back 112 button has been activated, indicating that the first URL is in the history. At FIG. 1C, the user clicks on a link and moves to a third URL, carpoint.msn.com/autopricer, and the Back 112 button remains active; the history contains the first and second URLs. At FIG. 1D, the user clicks on a link and moves to a fourth URL, zone.msn.com, and the Back 112 button remains active; the history now contains the first, second and third URLs. At FIG. 1E, the user clicks the Back button 112. Based on the stored history, the user moves back to the third URL, carpoint.msn.com/autopricer. Now, Back 112 button and the Forward 110 button have been activated, indicating ability to go further back into the history, or forward to the web page visited after the current one, e.g., the fourth URL. At FIG. 1F, the user clicks the Back 112 button. The user moves back to the second URL, carpoint.msn.com, and the Back 112 button and the Forward 110 button remain activated. At FIG. 1G, the user clicks the Back 112 button. The user moves back to the first URL, www.msn.com. The Forward 110 button remains activated, but the Back button is not since there are no web pages in the history before the first URL. At FIG. 1H, the user types in a new fifth URL, www.ibm.com. The Back 112 button has been activated, indicating the first URL is in the history. However the Forward button is not active, since browsing has now diverged from the original history and the previously stored second through fourth URLs have been discarded. At FIG. 1J, the user clicks the Back 112 button, and the user moves back to the first URL of www.msn.com, and only the Forward 110 button is available to move deeper into the www.msn.com web site. At FIG. 1K, the user is stuck with a loop-toggle between the first and fifth URLs without single-click access to any of the previously visited web pages.

### BRIEF DESCRIPTION OF THE DRAWINGS

In order to understand the manner in which embodiments of the present invention are obtained, a more particular description of various embodiments of the invention briefly described above will be rendered by reference to the appended drawings. Understanding that these drawings depict only typical embodiments of the invention that are not necessarily drawn to scale and are not therefore to be considered to be limiting of its scope, the embodiments of the invention will be described and explained with additional specificity and detail through the use of the accompanying drawings in which:

FIG. 1 are a schematic of conventional navigational buttons illustrating their active/inactive states during browsing;

FIG. 2 are a schematic of navigational buttons according to an embodiment buttons illustrating their active/inactive states during browsing;

FIG. 3 illustrate the active/inactive states of a menu-bar configuration of navigational buttons according to an embodiment;

FIG. 4 illustrate the active/inactive states of a menu-bar configuration of navigational buttons according to an embodiment;

FIG. 5 illustrate the active/inactive states of a menu-bar configuration of navigational buttons according to an embodiment;

FIG. 6 illustrate the active/inactive states of a menu-bar configuration of navigational buttons according to an embodiment;

FIG. 7 is a navigational map that illustrates forward and back navigation as well as branching according to an embodiment;

FIG. 8 is a navigational map that illustrates forward and back navigation as well as branching according to an embodiment;

FIG. 9 is a navigational map that illustrates forward and back navigation as well as branching according to an embodiment;

FIG. 10 is a navigational map that illustrates forward and back navigation as well as branching according to an embodiment;

FIG. 11 is a navigational map that illustrates forward and back navigation, identical to the browse history in FIG. 1, but according to another mapping embodiment;

FIG. 12 is a menu-bar configuration of navigational buttons according to an embodiment; and

FIG. 13 is a menu-bar configuration of navigational buttons according to an embodiment.

### DETAILED DESCRIPTION

The following description includes terms, such as first, second, etc. that are used for descriptive purposes only and are not to be construed as limiting. In the following detailed description, reference is made to the accompanying drawings, which form a part hereof. These drawings show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be used and structural, logical, and electrical changes may be made without departing from the scope of the present invention.

Throughout this disclosure, the term “clicking” can be used. Typically, this means a mouseclick, but other types of engaging a navigational action can be done. For example, a voice command can be the equivalent of a mouseclick on a button. Another example includes a touch-sensitive display that can be touched and that will engage a command that is the equivalent of a mouseclick on a button. Other types of engaging an navigational event can be done.

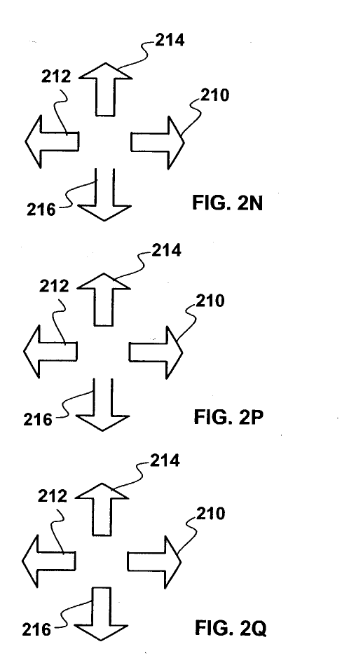

FIG. 2A is a schematic of navigational buttons according to an embodiment. The web browser interface includes a Forward 210 navigational button, a Back 212 navigational button, an Up 214 navigational button, and a Down 216 navigational button.

The following discussion is an exemplary embodiment that illustrates web navigation. In FIG. 2A, where a navigational button is illustrated as an open arrow shape, it is assumed to be “grayed out” according to conventional usage such that a mouse-click on a grayed-out navigational button does not result in a navigation action. Contrariwise, where a navigational button is illustrated as a closed arrow shape (see the Back 212 navigational button in FIG. 2B, for example), it is assumed to be active according to conventional usage such that a mouse-click on the navigational button can result in a navigation action.

According to the exemplary embodiment, a user starts by opening a web browser; by way of non-limiting example, to a first URL, www.msn.com. It is noted in FIG. 2A that the Forward 210, Back 212, Up 214, and Down 216 navigational buttons are all grayed out.

FIG. 2B is a schematic of the navigational buttons after further browsing from the navigational buttons in FIG. 2A. The user clicks on (or otherwise enters or selects) a link and moves to a second URL carpoint.msn.com/homepage, and the Back 212 navigational button has been activated, indicating that the first URL is in a history.

FIG. 2C is a schematic of the navigational buttons after further browsing from the navigational buttons in FIG. 2B. Next, the user clicks on a link and moves to a third URL, carpoint.msn.com/autopricer, and the Back 212 navigational button has been activated; the history contains the first and second URLs.

FIG. 2D is a schematic of the navigational buttons after further browsing from the navigational buttons in FIG. 2C. Next, the user clicks on a link and moves to a fourth URL zone.msn.com. Once again, the navigational button that has been activated is the Back 212 navigational button; the history now contains the first, second and third URLs.

FIG. 2E is a schematic of the navigational buttons after further browsing from the navigational buttons in FIG. 2D. According to an embodiment, the user clicks the Back 212 navigational button. The user moves back to the third URL carpoint.msn.com/autopricer. Now, the navigational buttons that have been activated include the Back 212 navigational button, as well as the Forward 210 navigational button according to an embodiment, indicating ability to go further back into the history, or forward to the web page visited after the current one, e.g., the fourth URL.

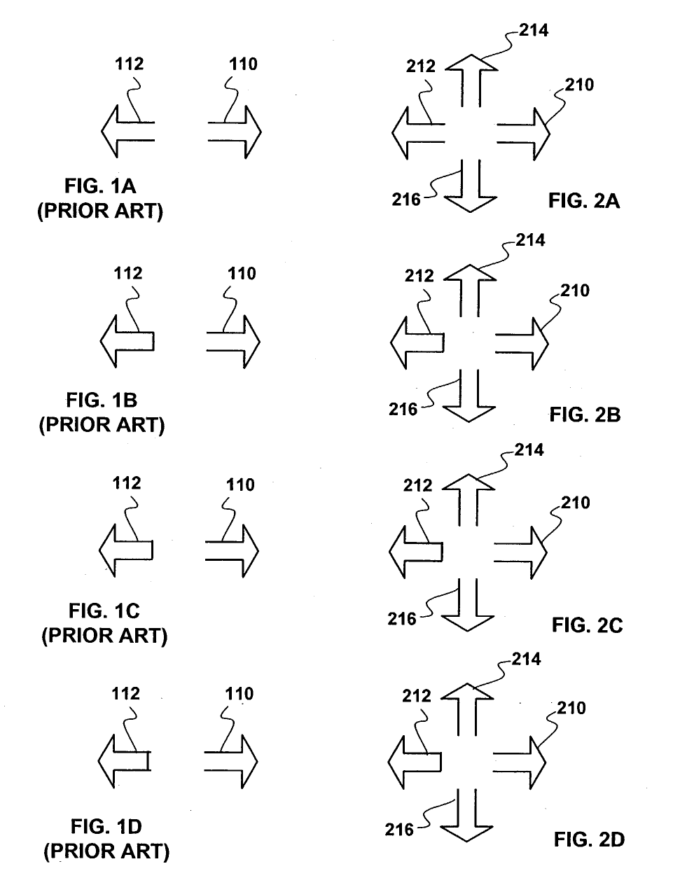

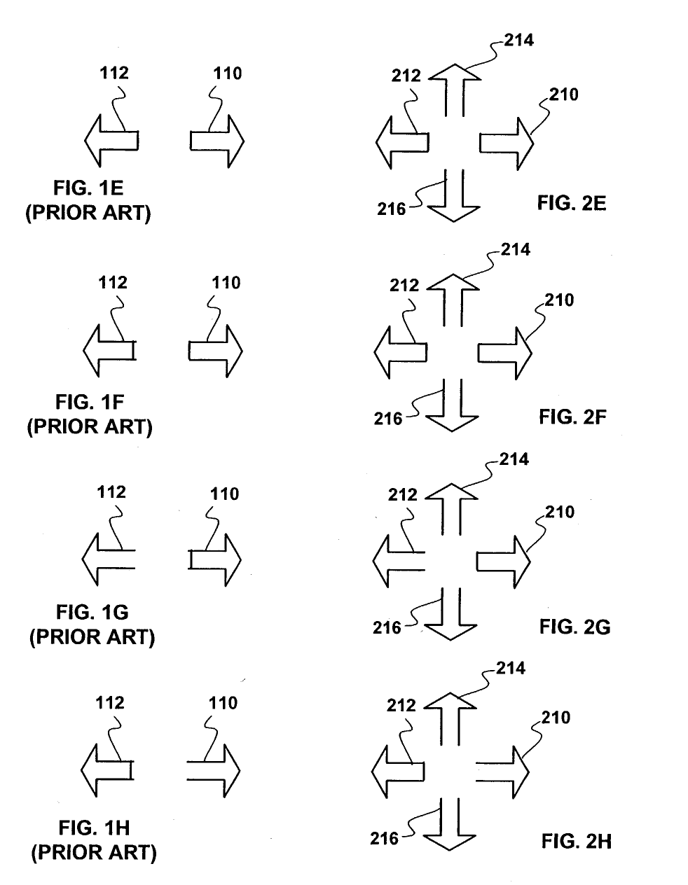

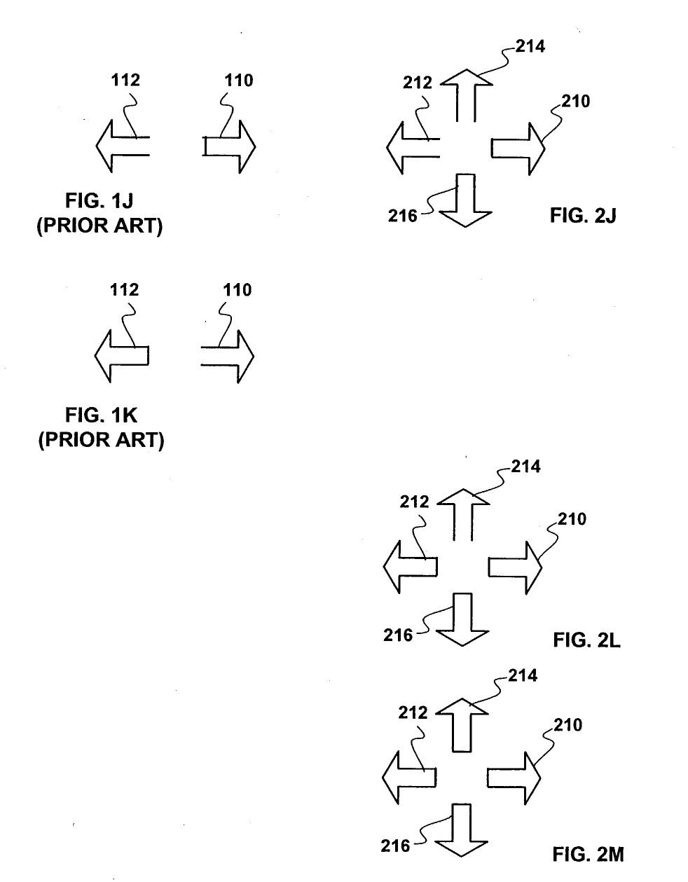

FIG. 2F is a schematic of the navigational buttons after further browsing from the navigational buttons in FIG. 1E. According to an embodiment, the user clicks the Back 212 navigational button. The user moves back to the URL carpoint.msn.com/homepage/default.asp. Now, the navigational buttons that have been activated include the Back 212 navigational button, as well as the Forward 210 navigational button according to an embodiment.

FIG. 2G is a schematic of the navigational buttons after further browsing from the navigational buttons in FIG. 2F. According to an embodiment, the user clicks the Back 212 navigational button. The user moves back to the URL www.msn.com, and the Forward 210 navigational button is activated according to an embodiment.

FIG. 2H is a schematic of the navigational buttons after further browsing from the navigational buttons in FIG. 2G. Next, the user types in a new URL: www.ibm.com, and the Back 212 navigational button has been activated.

FIG. 2J is a schematic of the navigational buttons after further browsing from the navigational buttons in FIG. 2H. According to an embodiment, the user clicks the Back 212 navigational button. The user moves back to the URL www.msn.com. Now, the navigational buttons that have been activated include the Forward 210 navigational button and the Down 216 navigational button according to an embodiment. By use of the browser interface, the user has not lost whatever search he has accomplished on the www.ibm.com web page.

By comparison to the conventional method, when the user clicks the Back 112 navigational button (FIG. 1J), the user moves back to the first URL of www.msn.com, and only the Forward navigational button is available to move deeper into the www.msn.com web site. Accordingly, the second URL site of www.ibm.com has been lost to the user, along with any sub-page searches.

FIG. 2L is a schematic of the navigational buttons after further browsing from the navigational buttons in FIG. 2J. The user clicks the Forward 210 navigational button and re-accesses the URL carpoint.msn.com/homepage/default.asp. At FIG. 2L, the Back 212 navigational button is for accessing the URL www.msn.com, the Forward 214 navigational button is available for accessing the URL carpont.msn.com/autopricer/default.asp?src=Hotme&pos=Res3, and the Down 216 navigational button is available for accessing the URL www.ibm.com. The Forward 212 navigational button in this embodiment allows the user to get to a previously visited page that would otherwise not be accessible by selecting a navigational button or the like.

FIG. 2M is a schematic of the navigational buttons after further browsing from the navigational buttons in FIG. 2L. The user clicks the Down 216 navigational button and re-accesses www.ibm.com. Here it is noted that the Forward 210 and Up 214 navigational buttons are activated. This means the user has not lost previous paths, but these paths were not accessible in the prior art.

FIG. 2N is a schematic of the navigational buttons after further browsing from the navigational buttons in FIG. 2L. This is an alternative path that the user can take according to an embodiment, when the user is at the juncture illustrated in FIG. 2L. The user clicks the Down 216 navigational button depicted in FIG. 2L, and the Forward, Back 212, and Up 214 navigational buttons are activated. At this juncture, both the Back 212 and the Up 214 navigational buttons are available to access the URL www.msn.com.

FIG. 2P is a schematic of the navigational buttons after further browsing from the navigational buttons in FIG. 2N. At FIG. 2P, the user types in the URL, www.intel.com. Now, the Forward 210, Back 212, and Up 214 navigational buttons are activated. At this juncture, the Up 214 navigational button is for accessing www.ibm.com.

FIG. 2Q is a schematic of the navigational buttons after further browsing from the navigational buttons in FIG. 2P. The user clicks the Up 214 navigational button. Now, all four navigational buttons, the Forward 210, Back 212, Up 214, and Down 216 navigational buttons are activated. The user moves back to the URL www.msn.com. The Down 216 navigational button is for accessing www.intel.com.

In one embodiment, the navigational buttons can be arrayed upon a menu bar. In one embodiment where the navigational buttons are arrayed upon a menu bar, the menu bar can show only those navigational buttons that are active. This embodiment allows for more space to exist on the menu bar for other functionalities. In another embodiment where the navigational buttons are arrayed upon a menu bar, the menu bar can show all navigational buttons, but the navigational buttons that are active are the only ones that are not grayed out. In another embodiment, sequential ordering of navigational buttons is carried out such that at least a partial browse-path history is displayed to the user. In another embodiment, the sequential history can place the active navigational button(s) in the center of a button menu bar such that a backtracking is also displayable.

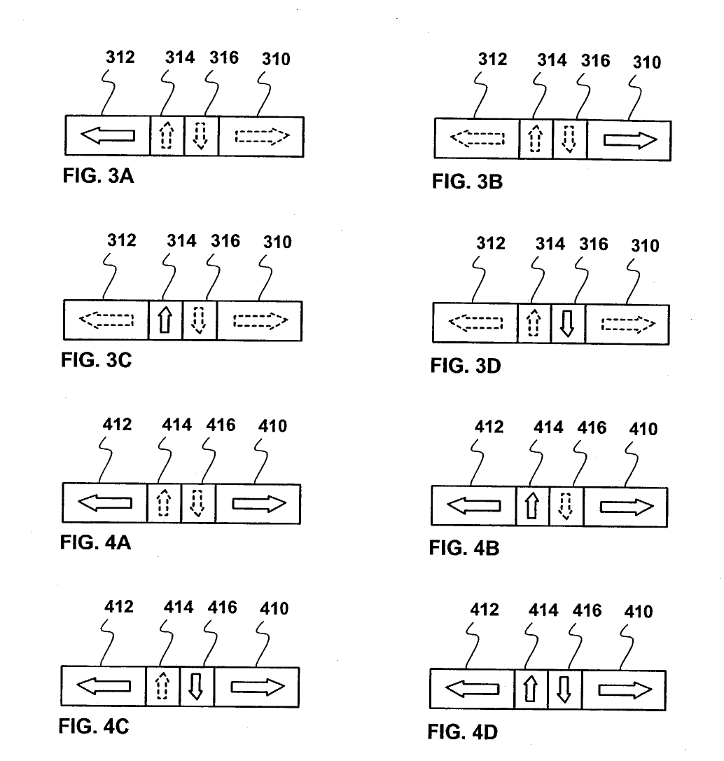

FIG. 3A is a menu-bar configuration of navigational buttons according to an embodiment. In FIG. 3A, a user has proceeded forward along a first path, such that a first URL has been exited. A back 312 navigational button is activated and the other navigational buttons, a Forward 310, an Up 314, and a Down 316 navigational button are grayed out. In one embodiment, a user reaches this menu-bar configuration by clicking on a link found at the previously exited URL.

FIG. 3B is a menu-bar configuration of navigational buttons according to an embodiment. In this embodiment, a user has backtracked from a previous URL, and there is no other browse history. Accordingly, the Forward navigational button 310 is activated, and the Back 312, Up 314, and Down 316 navigational buttons are grayed out.

FIG. 3C is a menu-bar configuration of navigational buttons according to an embodiment. According to this embodiment, a user has keyed in a URL while already at a previous URL. According to a convention established herein, the navigation has tracked the user's move “down” from the previous URL. Additionally, no further URLs have been accessed in this embodiment. Accordingly, the Up 314 navigational button is activated, and the Forward 310, Back 312, and Down 316 navigational buttons are grayed out.

FIG. 3D is a menu-bar configuration of navigational buttons according to an embodiment. According to this embodiment, a user has keyed in a URL while already at a previous URL. According to another convention established by the inventors, the navigation has tracked the user's move “up” from the previous URL. Additionally, no further URLs have been accessed in this embodiment. Accordingly, the Down 316 navigational button is activated, and the Forward 310, Back 312, and Up 314 navigational buttons are grayed out.

FIG. 4A is a menu-bar configuration of navigational buttons according to an embodiment. In this embodiment, the user has both Forward 410 and Back 412 navigational buttons active. Although the Up 414 and Down 416 navigational buttons are grayed out, they are present should the user key in a new URL, and one of them will become activated.

FIG. 4B is a menu-bar configuration of navigational buttons according to an embodiment. In this embodiment, the user has both Forward 410 and Back 412 navigational buttons active, as well as an Up 414 navigational button. According to a convention established herein, the navigation has tracked the user's move “down” from the previous URL. In one embodiment, the Up 414 navigational button is activated because the user had backtracked along a previous string of UPLs, and moved “down” by keying in a new URL. Previously, the user had proceeded forward at least two additional URLs, and then back at least one. Consequently, the Forward 410, Back 412, and Up 414 navigational buttons are active, but the Down 416 navigational button is grayed out.

FIG. 4C is a menu-bar configuration of navigational buttons according to an embodiment. In this embodiment, the user has both Forward 410 and Back 412 navigational buttons active, as well as a Down 416 navigational button. According to a convention established herein, the navigation has tracked the user's move “down” from a previous URL. In one embodiment, the Down 416 navigational button is activated because the user had backtracked along a previous string of URLs, and moved “up” by keying in a new URL. Previously, the user had proceeded forward at least two additional URLs, and then back at least one. Consequently, the Forward 410, Back 412, and Down 416 navigational buttons are active, but the Up 414 navigational button is grayed out.

FIG. 4D is a menu-bar configuration of navigational buttons according to an embodiment. In this embodiment, the user has both Forward 410 and Back 412 navigational buttons active, as well as Up 414 and Down 416 navigational buttons. According to a first convention established herein, the navigation has tracked the user's move “up” from a previous URL, but this is the second URL that the user has keyed in after commencing a browse session. Accordingly, the first URL that was keyed in was tracked as a move “down”. The second URL that was keyed in was tracked “up.” Previously, the user had moved forward from the second URL, and then back at least one. Accordingly, no navigational buttons are grayed out.

According to a second convention established herein, the navigation has tracked the user's move “down” from a previous URL, but this is the second URL that the user has keyed in. Accordingly, the first URL that was keyed in was tracked as a move “up”. The second URL that was keyed in was tracked “down.” Previously, the user had moved forward from the second URL, and then back at least one. Accordingly, no navigational buttons are grayed out.

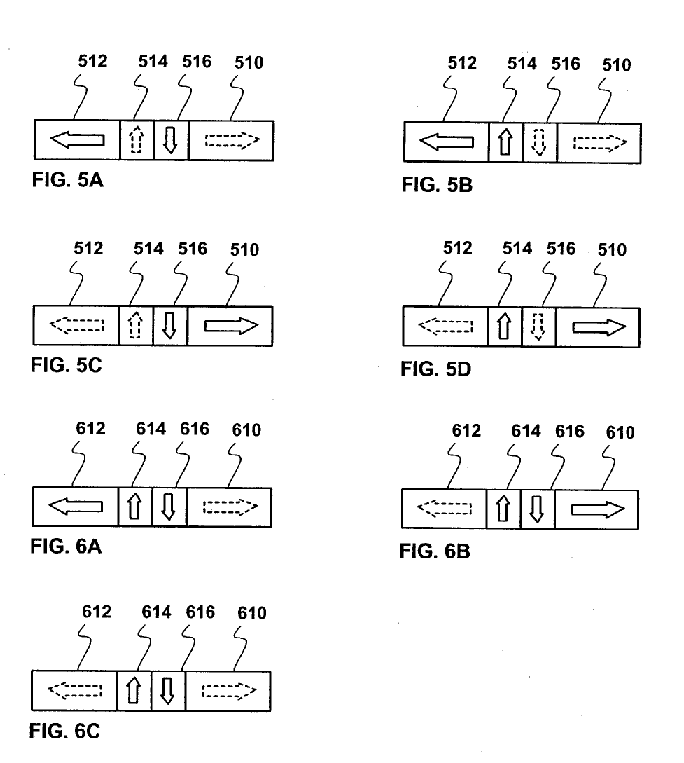

FIG. 5A is a menu-bar configuration of navigational buttons according to an embodiment. In this embodiment, the user has the Back 512 and Down 516 navigational buttons active. According to a convention established herein, the navigation has tracked the user's move “up” from a previous URL. Previously, the user had proceeded at least one URL forward, such that the Back 512 navigational button is active. Consequently, the Forward 510 and Up 514 navigational buttons are grayed out.

FIG. 5B is a menu-bar configuration of navigational buttons according to an embodiment. In this embodiment, the user has the Back 512 and Up 514 navigational buttons active. According to a convention established herein, the navigation has tracked the user's move “down” from a previous URL. Previously, the user had proceeded at least one URL forward, such that the Back 512 navigational button is active. Consequently, the Forward 510 and Down 516 navigational buttons are grayed out.

FIG. 5C is a menu-bar configuration of navigational buttons according to an embodiment. In this embodiment, the user has the Forward 510 and Down 516 navigational buttons active. According to a convention established herein, the navigation has tracked the user's move “up” from a previous URL. Previously, the user had proceeded at least one URL forward, such that the Back 512 navigational button is active. Consequently, the Forward 510 and Up 514 navigational buttons are grayed out.

FIG. 5D is a menu-bar configuration of navigational buttons according to an embodiment. In this embodiment, the user has the Forward 510 and Up 514 navigational buttons active. According to a convention established herein, the navigation has tracked the user's move “down” from a previous URL. Previously, the user had proceeded at least one URL forward, and then back to the keyed-in URL, such that the Forward 510 navigational button is active. Consequently, the Back 512 and Down 516 navigational buttons are grayed out.

FIG. 6A is a menu-bar configuration of navigational buttons according to an embodiment. In this embodiment, the user has the Back 612, Up 614, and Down 616 navigational buttons active. According to a first convention established herein, the navigation has tracked the user's move “up” from a previous URL, but this is the second URL that the user has keyed in. Accordingly, the first URL that was keyed in was tracked as a move “down”. The second URL that was keyed in was tracked “up.” Previously, the user had moved forward at least one URL from the second URL. Consequently, only the Forward 610 navigational button is grayed out.

According to a second convention established herein, the navigation has tracked the user's move “down” from a previous URL, but this is the second URL that the user has keyed in. Accordingly, the first URL that was keyed in was tracked as a move “up”. The second URL that was keyed in was tracked “down.” Previously, the user had moved forward from the second URL at least one URL, and then back to the second keyed-in URL. Consequently, only the Back 612 navigational button is grayed out.

FIG. 6B is a menu-bar configuration of navigational buttons according to an embodiment. In this embodiment, the user has the Forward 610, Up 614, and Down 616 navigational buttons active. According to a first convention established herein, the navigation has tracked the user's move “up” from a previous URL, but this is the second URL that the user has keyed in. Accordingly, the first URL that was keyed in was tracked as a move “down”. The second URL that was keyed in was tracked “up.” Previously, the user had moved forward at least one URL from the second URL, and then back to the second keyed-in URL. Consequently, only the Back 612 navigational button is grayed out.

According to a second convention established herein, the navigation has tracked the user's move “down” from a previous URL, but this is the second URL that the user has keyed in. Accordingly, the first URL that was keyed in was tracked as a move “up”. The second URL that was keyed in was tracked “down.” Previously, the user had moved forward from the second URL at least one URL, and then back to the second keyed-in URL. Consequently, only the Back 612 navigational button is grayed out.

FIG. 6C is a menu-bar configuration of navigational buttons according to an embodiment. In this embodiment, the user has the Back, 612, Up 614, and Down 616 navigational buttons active. According to a first convention established herein, the navigation has tracked the user's move “up” from a previous URL, but this is the second URL that the user has keyed in. Accordingly, the first URL that was keyed in was tracked as a move “down”. The second URL that was keyed in was tracked “up.” Consequently, the Forward 610 and Back 612 navigational buttons are grayed out.

According to a second convention established herein, the navigation has tracked the user's move “down” from a previous URL, but this is the second URL that the user has keyed in. Accordingly, the first URL that was keyed in was tracked as a move “up”. The second URL that was keyed in was tracked “down.” Consequently, the forward 610 and Back 612 navigational buttons are grayed out.

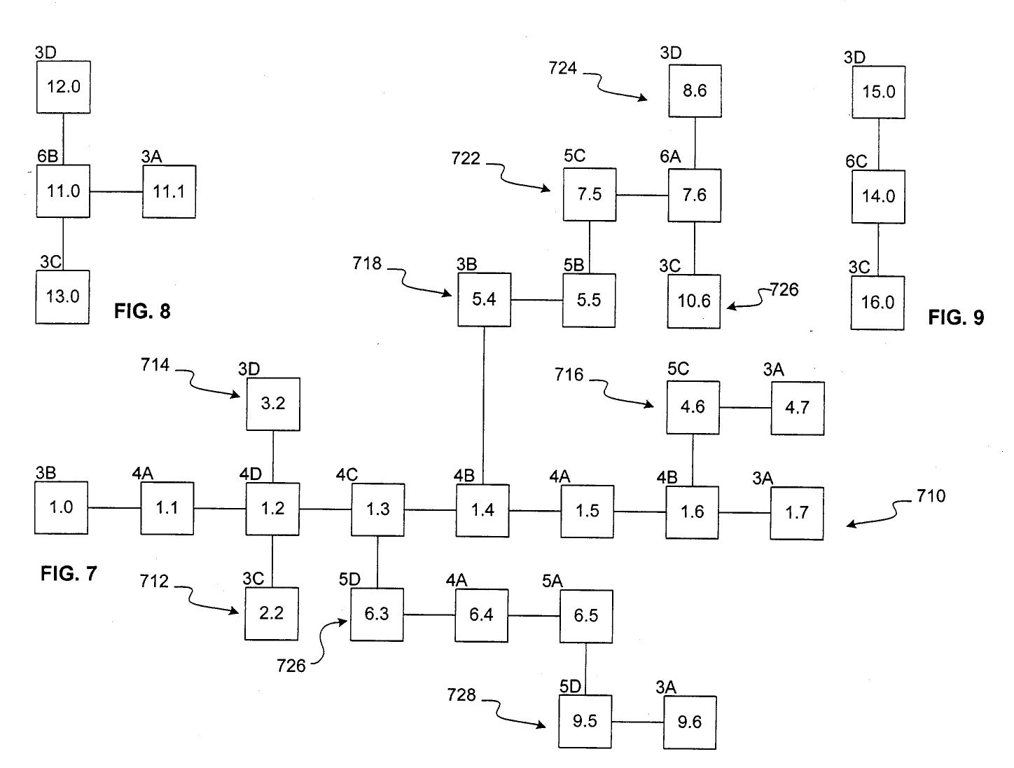

FIG. 7 is a navigational map that illustrates extensive forward and backward navigation as well as branching according to various embodiments. FIG. 7 is a simplified illustration of a browse history. In one embodiment, the browse history is referred to as a multi-linear history. Navigation is mapped according to a non-limiting “grid” embodiment in which the user branches between URLs as if the user had moved in two-dimensional space along linear and right angle paths. The rows along the grid represent strings of URLs that have been reached, either by keying in a URL or clicking on a link, or otherwise. The columns can be arbitrary position assignments to assist in establishing a visual and/or virtual grid for the user's convenience.

In FIG. 7, a primary URL string 710 is represented symbolically by URLs 1.0, 1.1, 1.2, 1.3, 1.4, 1.5, 1.6, and 1.7. The user accesses the URL 1.0 such as accessing the user's home page at the beginning of a browse session, by keying in the URL, by clicking on a link, or other conventional methods. In one embodiment, a “primary URL” is understood to be the first URL that is attained when the internet is accessed. In one embodiment, the primary URL is the user's default home page. In one embodiment, a primary URL is also part of an originally established string of URLs. For example, the URLs 1.0, 1.1, 1.2, 1.3, 1.4, 1.5, 1.6, and 1.7 can be referred to as a primary URL string.

A first secondary URL string 712 is represented symbolically by the URL 2.2. Because FIG. 7 is set forth in a grid, the URL 2.2 holds a columnar position “below” the URL 1.2, since it was accessed from the URL 1.2. The user accesses the URL 2.2 from the URL 1.2, by keying in the address for URL 2.2. According to an embodiment, a “secondary URL” is represented by a keyed-in URL that is accessed from a primary URL. A second secondary URL string 714 is represented symbolically by the URL 3.2. The user accesses the URL 3.2 from the URL 1.2, by keying in the address for URL 3.2. A third secondary URL string 716 is represented symbolically by the URLs 4.6 and 4.7. Similarly, a fourth secondary URL string 718 is represented symbolically by URLs 5.4, and 5.5. Similarly, a fifth secondary URL string 720 is represented symbolically by URLs 6.3, 6.4, and 6.5.

A first tertiary URL string 722 is represented symbolically by the URLs 7.5 and 7.6. From the tertiary URL 7.6, a first quaternary URL string 724 is represented symbolically by URL 8.6. Similarly, a second quaternary URL string 726 is represented symbolically by the URL 10.6. From the secondary URL 6.5, a tertiary URL string 726 is represented symbolically by the URLs 9.5 and 9.6.

FIG. 7 also presents a correlation between navigational button configurations depicted in several of FIGS. 3, 4, 5, and 6 and the graphic of a grid browse history, or a virtual grid browse history. The following examples are “connective branching” examples. By “connective branching” it is intended that the user retraces a browse path to reach a sequential, contiguous, previously accessed URLs according to an embodiment.

Branching can be by any method convenient to the user. In one embodiment, the user employs a mouse click or the like. In one embodiment, the user employs a graphical display command such as a point and click on a structure such as a navigational button menu bar or the like or such a browse path tree or the like such as is depicted in FIG. 7. In one embodiment, the user employs a voice command or the like. In one embodiment, the user employs a keyboard command or the like. In one embodiment, the user employs a physical command such as a non-conventional device used by a motor-handicapped individual for computer input. In one embodiment, the user employs combinations of the other embodiments.

Example 3A. Reference is made to FIG. 7. In this example, a method includes monitoring a navigation of a network application program from a first resource, URL 1.2, the navigation including backing up from a third resource, URL 2.2, to revisit a previously browsed second resource, URL 1.3, and browsing from the second resource, URL 1.3, to a fourth resource, URL 1.4. The method next includes preparing a multi-linear history based on the monitoring. In this example, the history includes a first traversal that is the navigation among the first, second and third resources, URL 1.2, URL 1.3, and URL 2.2, respectively. The history also includes a second traversal that is the navigation among the first, second and fourth resources, URL 1.2, URL 1.3, and URL 1.4, respectively.

Example 3B. In one embodiment, the URL 4.7 is accessed along the primary URL string 710, and then by keying in the URL 4.6 and browsing forward to the URL 4.7. The user sees the navigational button configuration depicted in FIG. 3A, and the user can access the URL 4.6 by clicking on the Back 312 navigational button.

Example 3C. In one embodiment, the URL 1.0 is accessed. The user has navigated backward such as by clicking the Back 312 navigational button. The user sees the configuration in FIG. 3B, and the user can access the URL 1.1 by clicking the Forward 310 navigational button.

Example 3D. In one embodiment, the URL 2.2 is accessed. The user sees the configuration depicted in FIG. 3C. The user can access the URL 1.2 by clicking the Up 314 navigational button.

Example 3E. In one embodiment, the URL 3.2 is accessed. The user sees the configuration depicted in FIG. 3D. The user can access the URL 1.2 by clicking the Down 316 navigational button.

Example 4A. In one embodiment, the URL 1.1 is accessed. The user sees the configuration depicted in FIG. 4A. The user can access the URL 1.0 by clicking the Back 412 navigational button. Alternatively, the user can access the URL 1.2 by clicking the Forward 410 navigational button.

Example 4B. In one embodiment, the URL 1.4 is accessed. The user sees the configuration depicted in FIG. 4B. The user can access the URL 1.3 by clicking the Back 412 navigational button. The user can also access the URL 1.5 by clicking the Forward 410 navigational button. Similarly, the user can access the URL 5.4 by clicking on the Up 414 navigational button.

Example 4C. In one embodiment, the URL 1.3 is accessed. The user sees the configuration depicted in FIG. 4C. The user can access the URL 1.2 by clicking the Back 412 navigational button. The user can also access the URL 1.4 by clicking the Forward 410 navigational button. Similarly, the user can access the URL 6.3 by clicking on the Down 416 navigational button.

Example 4D. In one embodiment, the URL 1.2 is accessed. The user sees the configuration depicted in FIG. 4D. The user can access the URL 1.1 by clicking the Back 412 navigational button. The user can also access the URL 1.3 by clicking the Forward 410 navigational button. Similarly, the user can access the URL 3.2 by clicking on the Up 414 navigational button. And similarly, the user can access the URL 6.3 by clicking on the Down 416 navigational button.

Example 5A. In one embodiment, the URL 6.5 is accessed. The user sees the configuration depicted in FIG. 5A. The user can access the URL 6.4 by clicking the Back 412 navigational button. The user can also access URL 9.5 by clicking on the Down 416 navigational button.

Example 5B. In one embodiment, the URL 5.5 is accessed. The user sees the configuration depicted in FIG. 5B. The user can access the URL 5.4 by clicking the Back 512 navigational button. The user can also access the URL 7.5 by clicking the Up 514 navigational button.

Example 5C. In one embodiment, the URL 7.5 is accessed. The user sees the configuration depicted in FIG. 5C. The user can access the URL 7.6 by clicking the Forward 510 navigational button. The user can also access the URL 5.5 by clicking the Down 516 navigational button.

Example 5D. In one embodiment, the URL 6.3 is accessed. The user sees the configuration depicted in FIG. 5D. The user can return to the URL 1.3 by clicking the Up 514 navigational button. The user can also return to the URL 6.4 by clicking the Forward 510 navigational button.

Example 6A. In one embodiment, the URL 7.6 is accessed. The user sees the configuration depicted in FIG. 6A. The user can return to the URL 7.5 by clicking the Back 612 navigational button. The user can also return to the URL 8.6 by clicking the Up 614 navigational button. The user can also return to the URL 10.6 by clicking the Down 616 navigational button.

FIG. 8 is a navigational map that illustrates forward and back navigation as well as branching according to various embodiments. Like the depiction in FIG. 7, navigation is mapped according to a grid convention in which the user branches between URLs as if the user had moved in two-dimensional space along linear and right-angle paths. The rows along the grid represent strings of URLs that have been reached, either by keying in a URL or clicking on a link, or otherwise. In FIG. 8, embodiments include navigational configurations that relate to FIGS. 3A, 3C, 3D, and 6B.

Example 6B. In one embodiment, the URL 11.0 is accessed and, the user has also accessed the URLs 12.0, 13.0, and 11.1. The user sees the configuration depicted in FIG. 6B. The user can return to the URL 12.0 by clicking the Up 614 navigational button. The user can also return to the URL 13.0 by clicking the Down 616 navigational button. Similarly, the user can return to the URL 11.1 by clicking the Forward 61 0 navigational button.

FIG. 9 is a navigational map that illustrates branching according to various embodiments. Like the depiction in FIGS. 7 and 8, navigation is mapped according to a grid convention. In FIG. 8, embodiments include navigational configurations that relate to FIGS. 3C, 3D, and 6C.

Example 6C. In one embodiment, the URL 14.0 is accessed and, the user has also accessed the URLs 15.0 and 16.0. The user sees the configuration depicted in FIG. 6C. The user can return to the URL 15.0 by clicking the Up 614 navigational button. The user can also return to the URL 16.0 by clicking the Down 616 navigational button.

In another embodiment, the user can display a navigational map that represents the browse history. For example, the user executes a “history” command that illustrates a browse history that resembles one of FIG. 7, FIG. 8, or FIG. 9 or a part of them, or the like as far as various URLs that have been accessed. Whereas the previous examples were illustrations of connective branching, in this embodiment, the graphical browse history allows for random-access branching. By “random-access branching” it is meant that the user can branch to any previously accessed URL by a graphical command. In one embodiment, a graphical command is used such as clicking on a URL representation in a graphical display. For example, if the user has generated a browse history such as that depicted in FIG. 7, and the user is presently URL 9.6, the user may, with a single command, select any other URL and branch to that URL.

In another embodiment, a user can “bookmark” a selected URL during a search session, and access the book marked URL by selecting one of the navigational buttons, or an equivalent event-driven command. By “bookmark” it is noted that the term can be used according to conventional uses. In one embodiment, it is a graphical display. In another embodiment it is a mental note during a browse session. With reference to FIG. 7 for example, a user can bookmark the URL 7.6, and then after accessing the URL 9.6, the user can click the Up 314 navigational button although it is grayed out (see FIG. 3A), and the search branches to the bookmark URL 7.6. A keyboard command combination can be used such as Shift, Up 314 for such branching. In another embodiment, the bookmark URL appears highlighted or otherwise distinguished when a browse history is displayed. When one of ordinary skill in the art reads this disclosure, other branching combinations can be made.

In another embodiment, the user desires to branch back to a previously accessed URL, but in the prior art, the state information of that URL has been lost. In this embodiment, the state information is preserved during the search session. When the user branches to the previously accessed URL, whether by connective branching, random-access branching, or another branching method, the state information is preserved for a given URL, and the URL is reactivated with the preserved state information.

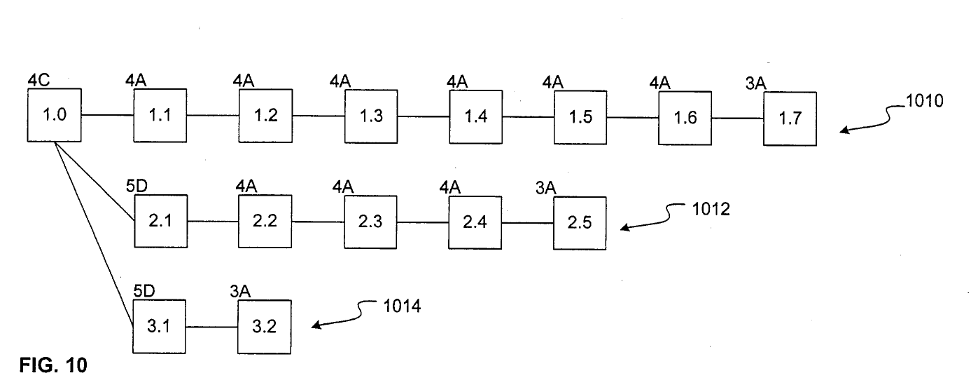

FIG. 10 is a simplified illustration of a graphical-time browse history according to an embodiment. In one embodiment, the history is referred to as a multi-linear history. In one embodiment, the browse history is referred to as a “daisy-chain” history. In this embodiment, a sequence-dependent browse history is generated. FIG. 10 is a navigational map that illustrates extensive forward and backward navigation as well as branching according to various embodiments. Navigation is mapped according to a non-limiting “multiple-parallel-string” embodiment in which the user branches between URLs as if the user had moved in two-dimensional space along linear and angled paths. The rows along the grid represent strings of URLs that have been accessed, either by keying in a URL or clicking on a link, or otherwise. The columns can be arbitrary position assignments to assist in establishing a visual and/or virtual grid for the user's convenience.

In FIG. 10, a primary URL string 1010 is represented symbolically by URLs 1.0, 1.1, 1.2, 1.3, 1.4, 1.5, 1.6, and 1.7. The user accesses the URL 1.0 such as accessing the user's home page at the beginning of a browse session, by keying in the URL, by clicking on a link, or other conventional methods. In one embodiment, a “primary URL” is understood to be the first URL that is attained when the internet is accessed. In one embodiment, the primary URL is the user's default home page. In one embodiment, a primary URL is also part of an originally established string of URLs. For example, the URLs 1.0, 1.1, 1.2, 1.3, 1.4, 1.5, 1.6, and 1.7 can be referred to as a primary URL string 1010.

A first secondary URL string 1012 is represented symbolically by the URLs 2.1, 2.2, 2.3, 2.4, and 2.5. The first secondary URL string 1012 was generated by the user backing up along the primary URL string 1010 until the URL 1.0 is re-accessed, and then by keying in a URL address that accesses URL 2.1. Because FIG. 10 is set forth in a sequence-dependent scheme that maps to the right for a primary URL string, and down for a secondary URL string, the URL 2.1 holds a columnar position “below” the URL 1.1, since it is the first URL that is accessed by keying in its URL address from the URL 1.0. From the position of URL 2.1, a first navigational event of engaging a Back command, results in accessing the URL 1.0. Next, from the position of URL 1.0, a second navigational event of engaging a Back command, results in remaining at the URL 1.0, but reactivating the primary URL string 1010, such that a Forward command re-accesses the URL 1.1 instead of the URL 2.1.

In this embodiment, the user accesses the URL 3.1 from the URL 1.0, by keying in the address for URL 3.1. According to an embodiment, a “secondary URL” is represented by a keyed-in URL that is accessed from a primary URL. A second secondary URL string 1014 is represented symbolically by the URLs 3.1 and 3.2. After generating the first secondary URL string 1012, the user accesses the URL 3.1 from the URL 1.0, by keying in the address for URL 3.1. Because FIG. 10 is set forth in a sequence-dependent scheme that maps to the right for a primary URL string, and downward for a secondary URL string, the URL 3.1 holds a columnar position “below” the URLs 1.1 and 2.1, respectively, since URL 3.1 is accessed by keying in its URL address from the URL 1.0 subsequent to access of the URL string 1012. From the position of URL 3.1, a first navigational event of engaging a Back command, results in re-accessing the URL 1.0. Next, from the position of URL 1.0, a second navigational event of engaging a Back command, results in remaining at the URL 1.0, but the first secondary URL string 1012 is activated, such that a Forward command re-accesses the URL 2.1. Next, from the position of URL 1.0, a third navigation event of engaging a Back command, results in remaining at the URL 1.0, but the first secondary URL string 1010 is activated, such that a Forward command re-accesses the URL 1.1.

By the navigational scheme depicted in FIG. 10, it becomes apparent that a “daisy chain” navigational scheme is created such that any URL that is accessed can be a branching node to a new URL string. In FIG. 10, the sole branching node is URL 1.0, but this is a non-limiting example.

Other navigational schemes can be generated by reading this disclosure and the appended claims. For example, in the daisy-chain scheme depicted in FIG. 10, if a user were at the URL 2.3 and engaged an Up command according to an embodiment, the navigational scheme lands the user at URL 1.3. Alternatively, the same Up command according to another embodiment, lands the user at URL 1.0. Similarly according to another example, if a user were at the URL 2.2 and engaged a Down command according to an embodiment, the navigational scheme lands the user at URL 3.2. Alternatively, the same Down command according to another embodiment lands the user at URL 3.1 such that any Down command lands the user at the first URL that was accessed subsequent to the generation of the URL string in which the user currently resides. According to one convention established by these examples, an Up command lands a user at the most recent branching node. In FIG. 10, this would always be URL 1.0. By the same convention, a Down command lands a user at the most recent first-accessed URL, from the most recent branching node. In FIG. 10, this would be URL 2.1 if the user were in the primary URL string 1010, or it would be URL 3.1 if the user were in the first secondary URL string 1012.

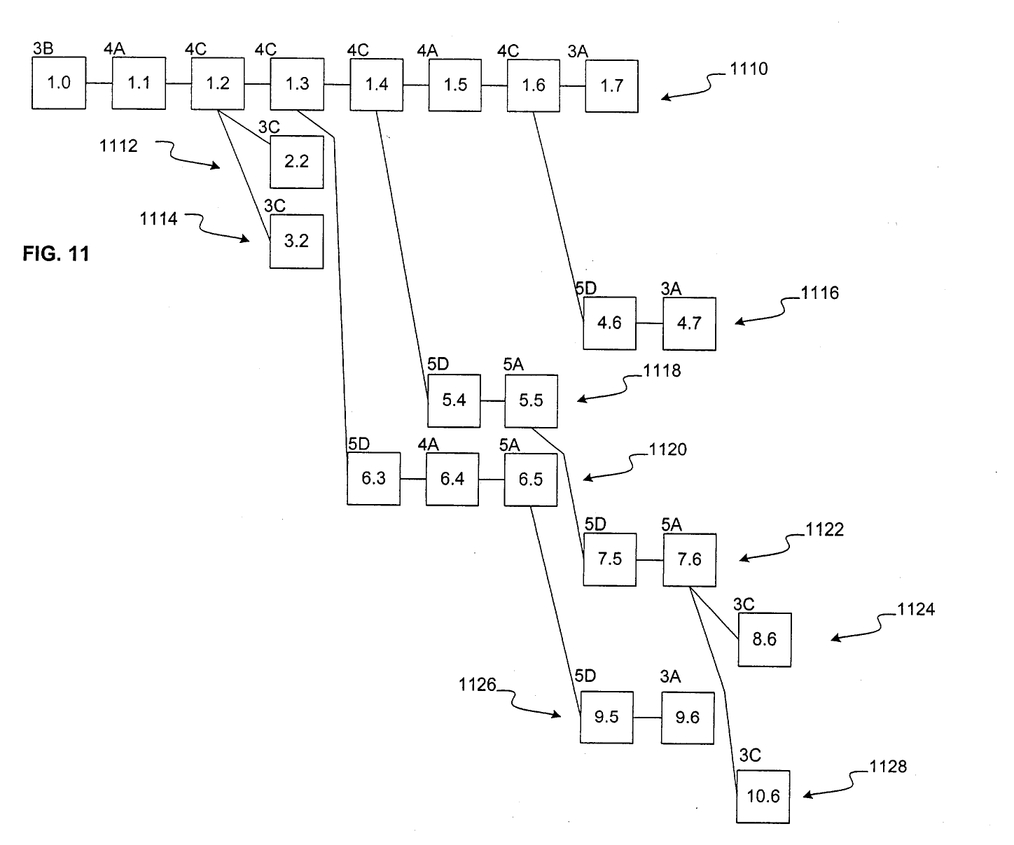

FIG. 11 is a navigational map that illustrates identical forward and backward navigation depicted in FIG. 7, but the browse history is mapped according to the embodiment depicted in FIG. 10. In one embodiment, the history is referred to as a multi-linear history. In one embodiment, the browse history is referred to as a “daisy-chain” history. In this embodiment, a sequence-dependent browse history is generated.

For clarity in FIG. 11, each URL is labeled identically as the plurality of URLs depicted in FIG. 7. But since the browse history of FIG. 7 is mapped into an embodiment according to the scheme depicted in FIG. 10, the graphic appears different from FIG. 7. In FIG. 11, there are the URL strings 1110, 1112, 1114, 1116, 1118, 1120, 1122, 1124, 1126, and 1128. These URL strings were generated in the absolute sequential order they are presented.

The browse history is also represented in a left-to-right relative access manner, along with the top-to-bottom absolute string-access manner. For example, the URL, URL 2.2 is shifted horizontally one column to the right of the URL 1.2 because it is accessed sequentially after URL 1.2, and it is shifted vertically one row below the URL string 1110 because it is accessed immediately after the generation of the URL string 1110. In another example, the URL 6.5 is in a URL string 1120 that was generated after the URL string 1118. The URL 6.5 is shifted to the right of the URL 6.4 because it was accessed from the URL 6.4, which in turn was accessed from the URL 6.3 The URL 6.3 is shifted one column to the right of the URL 1.3 because it is accessed from the URL 1.3. Similarly, the URL 6.3 is five rows below the URL 1.3 because it was accessed five URL string generations after the URL string 1110, in which the URL 1.3 is located.

According to an embodiment, branching can be by any method convenient to the user. In one embodiment, the user employs a mouse click or the like. In one embodiment, the user employs a graphical display command such as a point and click on a structure such as a navigational button menu bar or the like or such a multi-linear browse history or the like such as is depicted in FIG. 11.

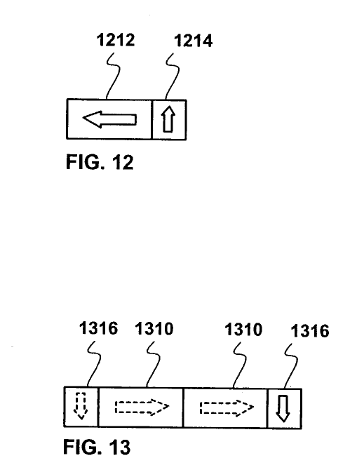

FIG. 12 is a menu-bar configuration of navigational buttons according to an embodiment. In this embodiment, the menu bar displays only those navigational buttons that are activated. In this embodiment, only the Back 1212 and Up 1214 navigational buttons are present. By way of non-limiting example (reference is to FIGS. 6-9), this embodiment is an alternative to the embodiment depicted in FIG. 5B. The other embodiments can be ascertained by similar reference to the FIGS. 3, 4, 5, and 6.

FIG. 13 is a menu-bar configuration of navigational buttons according to an embodiment. In this embodiment, the navigational buttons are rearranged according to the most recent URLs that the user has accessed. In a non-limiting example (reference is to FIGS. 6-9), a user has backtracked from the URLs 9.5, 6.5, 6.4, 6.3, and is at the URL 1.3. Accordingly, the menu-bar configuration represents the most recent branching history for an arbitrary number of four URLs. In another embodiment, only the most recently visited URL is pointed to by an activated navigational button. Accordingly, the activated navigational button can be at the left of a string of buttons, at the right, or somewhere in between. These configurations cause the activated navigational button(s) to appear in the context of a browse history.

On embodiment includes a method. In one embodiment, the method relates to navigating entirely within a single digital computer without a network connection. In another embodiment, the method relates to a method of navigating in the Internet with the software residing in the user's terminal. In another embodiment, the method relates to a method of navigating the Internet with the software residing at a remote server. In another embodiment, the method relates to a method of navigating the Internet with a remote server that downloads software to the user's terminal. The download is a one-time transmission that writes the software to the user's device. In another embodiment, the download is a real-time download from a server or the like, that is carried out each time the user accesses the server.

In one embodiment a method includes creating a first URL string. Next the method includes back-tracking along the first URL string. The method then includes creating a second URL string that originates from a URL on the first URL string. In this embodiment, the method concludes by branching to any URL on the first URL string.

In an exemplary embodiment depicted in FIG. 7, the method commences by the user creating the URL string 710 up to at least URLs 1.0, 1.1, 1.2, 1.3, and 1.4. Next the method includes back-tracking along the first URL string 710 to the URL 1.3. The method then includes creating a second URL string 726 that originates from a URL (1.3) on the first URL string 710. In this embodiment, the user accesses the URLs 6.3, 6.4, and 6.5. In this embodiment, the method concludes by branching from the URL 6.5 to any URL on the first URL string 710. For example, the user carries out connective branching to the URL 1.4, by a series of navigational button selections including Back 512 (FIG. 5A), Back 412 (FIG. 4A), Up 514 (FIG. 5D), and Forward 410 (FIG. 4C).

In an alternative embodiment, the second URL string is URL string 712. Hence, the second URL string 712 can include a single URL. In this embodiment, the method concludes by branching from the URL 2.2 to any URL on the first URL string 710. For example, the user carries out connective branching to the URL 1.4, by a series of navigational button selections including Up 314 (FIG. 3C), Forward 410 (FIG. 4C), and Forward 410 (FIG. 4C).

In another embodiment, the user employs random-access branching. In this method, the user displays the first URL string such as by a display command. Thereafter, the user selects any URL on the first URL string. In an exemplary embodiment, the user has navigated the entire series of URL strings depicted in FIG. 7, and is located at any URL except the URL 5.5. Next, the user executes a display command that displays at least the URL string 718. Finally, the user uses a single, or simple command that branches to the URL 5.5.

In another embodiment, software conducts linear mapping a first string of n URLs. For this embodiment, n is greater than or equal to 3, but in another embodiment, n can be equal to 2. The user navigates until an n-i^{th} URL is accessed. This URL is at least one backtracked URL. Therefore, “i” is less than or equal to n-1, and the n-i^{th} URL forms a node for a first branch that includes the n-i^{th} URL. Further, the n-i^{th} URL forms a node for a second branch the user has navigated that includes a m^{th} URL. The user completes a navigation by navigating between the n^{th} URL and the m^{th} URL by at least one branching command.

In an exemplary embodiment depicted in FIG. 7, the n^{th} URL string terminus is designated as URL 1.7. The n-i^{th} URL is URL 1.4. Hence “i” is equal to 3. Previously, the user had navigated to the URL 7.6. URL 7.6 represents a second URL string terminus; the m^{th} URL and m is equal to 2. The user completes the navigation between URL 1.7 and URL 7.6 by branching to URL 7.6 according to any one of the various embodiments, and their equivalents set forth herein.

It is noted that several method algorithms are set forth in this disclosure. Accordingly it is an embodiment to include a computer-readable medium having instructions stored thereon for causing a device to perform a method according to the various embodiments set forth herein.

It is noted that a system embodiment is set forth in this disclosure. One system embodiment includes a web browser interface including at least one of the menu-bar configurations set forth therein. For example, in addition to a Back and a Forward navigational functionality, a system embodiment includes at least one of an Up or a Down navigational functionality. In one embodiment, the navigational functionality has a directional arrow functionality as set forth herein. In one embodiment, the system includes a latest-site-navigated button order hierarchy as set forth herein. In another embodiment the system includes the navigational functionality that displays only active navigational buttons.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in-the subjoined claims.

What is claimed is:

1. A method comprising:
monitoring a navigation of a network application program from a first resource, the navigation including backing up from a third resource to revisit a previously browsed second resource, and browsing from the second resource to a fourth resource; and
preparing a multi-linear history based on the monitoring, the history having a first traversal comprising the first, second and third resources, and a second traversal comprising the first, second and fourth resources.

2. The method of claim 1, wherein the first resource includes a first branching node in the navigation, and the first resource included in a first primary URL string, and a first secondary URL string, the method further including:
from a URL in the first primary URL string, engaging an Up traversal request, that returns the user to the first resource.

3. The method of claim 1, wherein the first resource includes a first branching node in the navigation, and the first resource included in a first primary URL string, and a first secondary URL string, the method further including:
from a URL in the first secondary URL string, engaging an Up traversal request, that returns the user to the first resource.

4. The method of claim 1, wherein the first resource includes a first branching node in the navigation, and the first resource included in a first primary URL string, a first secondary URL string, and a second secondary URL string, the method further including:
from a URL in the first secondary URL string, engaging a Down traversal request, that returns the user to the second secondary URL string, to a resource that is adjacent the first resource.

5. A method comprising:
monitoring a navigation of a network application program from a first resource, the navigation including backing up from a second resource to re-access the first resource, and browsing from the first resource to access a third resource;
preparing a multi-linear history based on the monitoring, the history having a first traversal comprising the first and second resources, and a second traversal comprising the first and third resources; and
receiving an Up traversal request and responsive thereto directing the network application program to browse from the third resource to re-access the second resource.

6. The method of claim 5, further including:
responsive to the Up traversal request, associating a Back button with the first traversal.

7. The method of claim 6, further including:
associating a Back traversal request with the first resource.

8. A method comprising:
creating a first URL string;
back-tracking along the first URL string;
creating a second URL string that originates from a branch node on the first URL string; and
branching from the second URL string to a URL on the first URL string.

9. The method of claim 8, wherein a browser creates the first and the second URL strings while browsing.

10. The method of claim 8, further including:
associating Up, Down, Back, and Forward buttons of a browser with selected URLs of the first and second URL strings.

11. The method according to claim 8, wherein creating the second URL string includes creating a single URL.

12. The method of claim 8, wherein branching is selected from a mouse click, a graphical display command, a voice command, a keyboard command, a physical command, and combinations thereof.

13. The method of claim 8, wherein the branching includes a directional command that relates to at least one of an Up command and a Down command.

14. The method of claim 8, wherein branching to the URL on the first URL string includes:
displaying the first URL string; and
receiving a selection of the URL on the first URL string.

15. A method comprising:
linear mapping a first string of n URLs, wherein n is greater than or equal to 2, until an n-i^{th} URL is accessed, wherein i is less than or equal to n-1, wherein the n-i^{th} URL forms a node for a first branch that includes the n-i^{th} URL, and wherein the n-i^{th} URL forms a node for a second branch that includes an m^{th} URL; and
navigating between the n^{th} URL and the m^{th} URL by at least one branching command.

16. The method according to claim 15, wherein the at least one branching command includes at least one of an Up navigational command and a Down navigational command.

17. The method according to claim 15, wherein the n^{th} URL forms a first URL string terminus, and wherein the m^{th} URL forms a second URL string terminus, the method further including:
from the first URL string terminus, initiating one of an Up navigational command and a Down navigational command, wherein the navigational command branches to the second URL string terminus; or
from the second URL string terminus initiating one of an Up navigational command and a Down navigational command, wherein the navigational command branches to the first URL string terminus.

18. The method according to claim 15, wherein the n^{th} URL forms a first URL string terminus, and wherein the m^{th} URL forms a second URL string terminus, the method further including:
from the first URL string terminus, initiating one of an Up navigational command and a Down navigational command, wherein the navigational command branches to the second URL string terminus, wherein the navigational command includes displaying the first URL string and the second URL string, and graphically selecting the second URL string terminus; or
from the second URL string terminus initiating one of an Up navigational command and a Down navigational command, wherein the navigational command branches to the first URL string terminus, wherein the navigational command includes displaying the first URL string and the second URL string, and graphically selecting the first URL string terminus.

19. The method according to claim 15, wherein the n^{th} URL forms a first URL string terminus, and wherein the m^{th} URL forms a second URL string terminus, the method further including:
from a URL on the first URL string, initiating a navigational command, wherein the command branches to a URL on the second URL string, wherein the navigational command includes displaying the second URL string, and graphically selecting the a URL on the second URL string; or
from a URL on the second URL string, initiating a navigational command, wherein the command branches to a URL on the first URL string, wherein the navigational command includes displaying the first URL string and graphically selecting a URL on the first URL string.

20. The method according to claim 15, wherein the n^{th} URL forms a first URL string terminus, and wherein the m^{th} URL forms a second URL string terminus, the method further including:
distinguishing a URL on the first URL string; and
initiating a navigational command, wherein the command branches to the distinguished URL on the second URL string; or
distinguishing a URL on the second URL string; and
initiating a navigational command, wherein the command branches to the distinguished URL on the first URL string.

21. A machine accessible medium having instructions stored thereon for causing a device to perform a method, the method comprising:
creating a first URL string;
back-tracking along the first URL string;
creating a second URL string that originates from a URL on the first URL string; and
branching to any URL on the first URL string.

22. The machine accessible medium according to claim 21, wherein the method of creating the second URL string includes creating a single URL.

23. The machine accessible medium according to claim 21, wherein the method of branching includes a directional command that relates to at least one of an Up command and a Down command.

24. A user interface comprising:
a first browse history;
a second browse history;
a branching command that enables branching from any URL on the second browse history to any URL on the first browse history.

25. The user interface according to claim 24, wherein the branching command includes at least one of an Up command and a Down command.

26. The user interface according to claim 24, wherein the branching command is selected from sequential URL branching and random-access URL branching.

27. A system comprising:
in a web browser interface, in addition to a Back and a Forward navigational functionality, at least one of an Up or a Down navigational functionality.

28. The system according to claim 27, wherein the navigational functionality has a directional arrow functionality.

29. The system according to claim 27, wherein the navigational functionality is displayed in the interface with a latest-site-navigated button order hierarchy.

30. The system according to claim 27, wherein the navigational functionality displays only active navigational buttons.

31. The system according to claim 27, wherein the navigational functionality displays the active navigational button(s) in the context of a browse history.
